(19) United States
(12) Patent Application Publication
(10) Pub. No.: US 2026/0246482 A1
(43) Pub. Date: Aug. 20, 2026

(54) UNIFIED RECEIVER ARCHITECTURE FOR A PLURALITY OF WIRELESS PROTOCOLS

(71) Applicant: Silicon Laboratories Inc., Austin, TX (US)

(72) Inventors: Rangakrishnan Srinivasan, Austin, TX (US); Abdulkerim Coban, Austin, TX (US); Jagadish Yadav, Hyderabad (IN); Yu Su, Austin, TX (US); Sherry Wu, Austin, TX (US); Ayman Shafik, Austin, TX (US); Anil Kumar Adavally, Hyderabad (IN)

(21) Appl. No.: 19/055,050

(22) Filed: Feb. 17, 2025

(51) Int. Cl. H04B 1/00

(52) U.S. Cl. CPC H04B 1/0071; H04B 1/0007; H04B 1/0078; H04B 1/0096

(57) ABSTRACT

In one embodiment, a receiver includes: a low noise amplifier (LNA) to receive and amplify a radio frequency (RF) signal; a mixer to downconvert the RF signal to an intermediate frequency (IF) signal; a programmable gain amplifier (PGA) to amplify the IF signal; a first digitizer coupled to the PGA to digitize the IF signal to a first digitized signal when the RF signal is of a first wireless protocol; a second digitizer coupled to the PGA to digitize the IF signal to a second digitized signal when the RF signal is of a second wireless protocol; and a controller to direct the IF signal to the first digitizer via a first path when the first wireless protocol is active and to direct the IF signal to the second digitizer via a second path when the second wireless protocol is active.

### BACKGROUND

In a radio receiver, an incoming radio frequency (RF) signal is received via an antenna. The signal is then processed in a signal processing path of the receiver. General receive operations include amplification, downconversion, filtering and digitization, resulting in a digitized signal that can then be digitally processed, such as by demodulation for a particular modulation technique.

Different wireless protocols have different requirements for parameters such as throughput, sensitivity and blocking requirements. For protocols having higher requirements for these or other parameters, a receiver is designed for higher performance, which typically incurs greater chip area and power consumption.

It is possible for multiple wireless protocols to use a common receiver. However, when higher and lower performance requirement protocols share a common receiver, the receiver is not of an optimal design for the lower performance requirement wireless protocol, due in part to high receiver power consumption. In general, the receiver is over-designed for requirements of at least the lower performance requirement-protocol, unnecessarily increasing power consumption.

### SUMMARY OF INVENTION

In one aspect, a receiver includes: a low noise amplifier (LNA) to receive and amplify a radio frequency (RF) signal; a mixer to downconvert the RF signal to an intermediate frequency (IF) signal; a programmable gain amplifier (PGA) coupled to the mixer to amplify the IF signal; a first digitizer coupled to the PGA to digitize the IF signal to a first digitized signal when the RF signal is of a first wireless protocol; a second digitizer coupled to the PGA to digitize the IF signal to a second digitized signal when the RF signal is of a second wireless protocol; and a controller to direct the IF signal to the first digitizer via a first path when the first wireless protocol is active and to direct the IF signal to the second digitizer via a second path when the second wireless protocol is active.

In one implementation, the receiver further comprises switching circuitry, and the controller is to control the switching circuitry to: direct the IF signal to the first digitizer via the first path when the first wireless protocol is active; and direct the IF signal to the second digitizer via the second path when the second wireless protocol is active.

In one implementation, the first path comprises a filter coupled between the PGA and the first digitizer, and the second path comprises a direct path between the PGA and the second digitizer.

In an implementation: the first digitizer has a first power consumption level; and the second digitizer has a second power consumption level, the second power consumption level lower than the first power consumption level. The first digitizer may be a wide-band analog-to-digital converter (ADC), and the second digitizer may be a narrow-band ADC. The controller may be configured to disable at least the first digitizer when the second wireless protocol is active. In one implementation, the second digitizer is further to digitize sensor information when the first wireless protocol is active.

In an implementation, the receiver further comprises: a first demodulator coupled to the first digitizer, the first demodulator to demodulate the first digitized signal according to a first demodulation scheme; and a second demodulator coupled to the second digitizer, the second demodulator to demodulate the second digitized signal according to a second demodulation scheme. The receiver may also include: a first power detector coupled to an input of the LNA, the first power detector to output a first detection signal in response to the RF signal exceeding a first threshold; and a second power detector coupled to an output of the first digitizer, the second power detector to output a second detection signal in response to the first digitized signal exceeding a second threshold, wherein the controller is to control at least one gain component of the receiver based at least in part on the first detection signal or the second detection signal. The receiver also may include a third power detector coupled to an output of the PGA, wherein the third power detector is active when the second wireless protocol is active.

In another aspect, a method includes: when a first wireless protocol is active, configuring, via a controller, a unified receiver to provide a downconverted signal to a first path of the unified receiver, the first path comprising a filter to filter the downconverted signal and a first digitizer to digitize the filtered downconverted signal into a first digital signal; and when a second wireless protocol is active, configuring, via the controller, the unified receiver to provide the downconverted signal to a second path of the unified receiver, the second path comprising a second digitizer to digitize the downconverted signal into a second digital signal.

In one implementation, the method further includes configuring the unified receiver in response to mode information, the mode information to indicate whether the first wireless protocol or the second wireless protocol is active. The method also may include dynamically re-configuring the unified receiver from providing the downconverted signal to the first path to providing the downconverted signal to the second path in response to updated mode information that indicates that the second wireless protocol is active.

In one implementation, configuring the unified receiver may include controlling switch circuitry coupled to the first path and the second path, the switch circuitry to receive the downconverted signal from a common path of the unified receiver, the common path to receive and downconvert a radio frequency signal to the downconverted signal, the common path active when the first wireless protocol is active and when the second wireless protocol is active. Configuring the unified receiver may include: configuring the first digitizer to have a first power consumption level when a first mode of the first wireless protocol is active; and configuring the first digitizer to have a second power consumption level when a second mode of the first wireless protocol is active, the second power consumption level less than the first power consumption level.

In one implementation, the method further comprises: processing the downconverted signal in the first path at a first power consumption level; and processing the downconverted signal in the second path at a second power consumption level, the second power consumption level less than the first power consumption level.

In yet another aspect, a wireless device includes: an antenna to transmit a transmit RF signal and to receive a receive RF signal; and an integrated circuit (IC) coupled to the antenna. The IC may include: a LNA to receive and amplify the receive RF signal; a mixer to downconvert the receive RF signal to a second frequency signal; an amplifier coupled to the mixer to amplify the second frequency signal; a first path comprising a filter to filter the second frequency signal and a first digitizer coupled to the filter to digitize the filtered second frequency signal to a first digitized signal; a second path comprising a second digitizer to digitize the second frequency signal to a second digitized signal; a first demodulator coupled to the first path to demodulate the first digitized signal; a second demodulator coupled to the second path to demodulate the second digitized signal; and a controller to direct the second frequency signal to the first path when a first wireless protocol is active and to direct the second frequency signal to the second path when a second wireless protocol is active.

In one implementation, the controller is to disable the filter and the first digitizer when the second wireless protocol is active. The second digitizer may be configured to digitize sensor information when the first wireless protocol is active, and to digitize the second frequency signal to the second digitized signal when the second wireless protocol is active, the second digitizer to operate at a lower power consumption level than the first digitizer.

### BRIEF DESCRIPTION OF THE DRAWINGS

FIG. 1 is a block diagram of an apparatus having a unified receiver architecture in accordance with an embodiment.

FIG. 2A is a block diagram of a receiver configured in a first mode in accordance with an embodiment.

FIG. 2B is a block diagram of a receiver configured in a second mode in accordance with an embodiment.

FIG. 3 is a block diagram of a receiver configured in a third mode in accordance with an embodiment.

FIG. 4 is a flow diagram of a method in accordance with an embodiment.

FIG. 5 is a block diagram of a representative integrated circuit in accordance with an embodiment.

FIG. 6 is a high-level diagram of a network in accordance with an embodiment.

### DETAILED DESCRIPTION

In various embodiments, a unified receiver architecture is provided that can be used for communications of multiple wireless protocols. Such protocols may have different requirements for a variety of parameters, with one of the wireless protocols having higher performance requirements for one or more of linearity, noise performance, blocker tolerance profile, and so forth, which leads to higher power consumption during operation of the receiver for this protocol. However, when another wireless protocol is active that has more relaxed requirements for one or more of these parameters (e.g., degraded sensitivity, less tolerance to high blocker levels, and/or similar sensitivity in a much lower bandwidth) for a lower power implementation, the receiver can be dynamically configured to enable operation at lower power consumption levels.

With embodiments, the unified receiver architecture can be dynamically controlled based on active wireless protocol to optimize performance for that active wireless protocol, to realize lower power consumption when possible for lower power-consuming wireless protocols. In this way, a single unified receiver architecture is provided that can be optimized for use by multiple wireless protocols.

As examples, a unified receiver architecture can be used in connection with various packet-based wireless protocols such as Wi-Fi, Bluetooth™ (Classic or Low Energy), Zigbee™, as well as many other Internet of Things (IoT) protocols. Embodiments may be applicable to receivers for both constant amplitude modulated signals (such as frequency shift keying (FSK), Gaussian frequency shift keying (GFSK), minimum shift keying (MSK)), and/or other IoT standards and non-constant amplitude modulated signals (such as OFDM).

For purposes of discussion herein, a receiver operating in a Wi-Fi operating mode according to a given IEEE 802.11 specification (such as any one of IEEE 802.11a/b/g/n/ac/ax/be specifications, typically from MCS0 to MCS11 or higher as applicable) will be used as an example of a high-performance requirement wireless protocol, while in turn the same receiver operating in a Bluetooth operating mode (Bluetooth Classic or Bluetooth Low Energy) will be used as an example of a low-performance requirement wireless protocol that has been optimized for low-power. Understand however that embodiments are not limited to these examples, and a receiver may operate in high and low performance modes according to other wireless protocols.

In general, for a high-performance requirement wireless protocol, a receiver is designed for high throughput at improved sensitivity levels in presence of strong blockers. These requirements demand low noise figure and high linearity radio receiver designs with wide bandwidth support. Such requirements lead to high current consumption. In contrast, a receiver for a low-power requirement wireless protocol has relaxed requirements for all the above specifications (or similar requirements in a much narrower bandwidth), and the receiver is designed to optimize operation at reduced current consumption to tradeoff with performance. As used herein, the terms “high” and “low” are used in conjunction with discussion of performance requirements and/or power, and are used to connote a relative level of such parameters.

In one or more embodiments, design requirements for different wireless protocols are decoupled, and a unified receiver architecture is provided for operation in high-performance requirement and low-power requirement wireless protocols, without compromising on performance for each mode. To this end, a controller is adapted to dynamically configure the unified receiver for a given operating mode. For example, when a low-power requirement wireless protocol such as a Bluetooth protocol is active, the controller configures the receiver in a low-current mode to meet requirements of the protocol with significantly reduced current consumption (e.g., approximately 70% lower than for a high-performance mode). In turn, when a high-performance requirement wireless protocol such as a Wi-Fi protocol is active, the controller configures the receiver in a higher-current mode to meet requirements of the protocol. In some implementations, in a high-performance mode, it is possible for the controller to further configure the receiver to reduce power consumption for certain activity in the high-performance mode, such as beacon purposes (e.g., IEEE 802.11b and lower MCS conditions for IEEE 802.11a/g/n/ac/ax/be, typically from MCS0 to MCS4). In a particular operation, this lower power operation can reduce power consumption by approximately 25%.

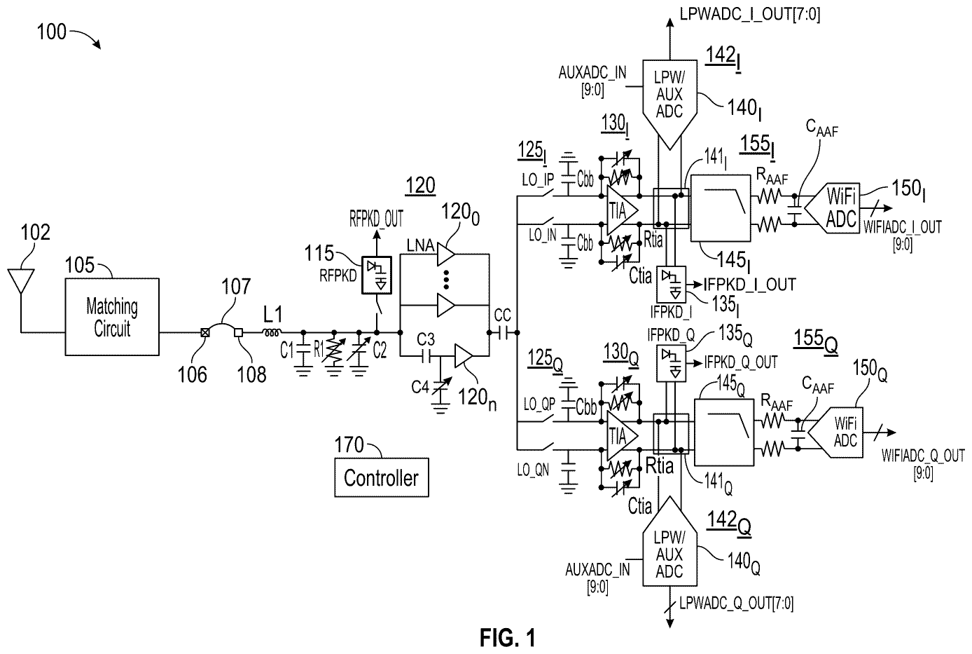

Referring now to FIG. 1, shown is a block diagram of an apparatus having a unified receiver architecture in accordance with an embodiment. As shown in FIG. 1, receiver 100 is a radio receiver that may be adapted in any type of wireless device. In various embodiments, an antenna 102 receives incoming RF signals and provides them to a matching circuit 105. In an embodiment, matching circuit 105 may be implemented as an LC circuit having at least one series-coupled inductor and a parallel-coupled capacitor. In an embodiment, matching circuit 105 may be implemented as discrete components adapted on a circuit board, such that matching circuit 105 is external to circuitry within an integrated circuit having additional circuitry of receiver 100.

As shown in FIG. 1, the RF signal couples via pins 106, 108 and bond wire 107 to circuitry of receiver 100 that is implemented on an integrated circuit (IC). The RF signal may be attenuated via attenuator circuitry that may be implemented as a passive gain network, e.g., including a parallel-coupled capacitance C4 and resistance R1. In different embodiments, one or more of these RC components can be dynamically controlled to control an amount of attenuation, such that this front-end attenuator circuitry is considered one of a plurality of gain components of receiver 100, namely a first gain control region of receiver 100. Although embodiments are not limited in this regard, in one particular embodiment this attenuator circuitry may provide for a controllable gain of −15 dB to 9 dB (e.g., with 2 dB steps per update). In one embodiment, the resistance R1 may be dynamically controlled to adjust the gain setting of the first gain control region.

As further illustrated in FIG. 1, on-chip matching circuitry to present an optimal impedance at pin 108 may be implemented with an inductor L1 and a parallel-coupled capacitance C1. As further shown, another parallel-coupled capacitor C2 may be implemented as a programmable tuning capacitance for band tuning. After any attenuation in the attenuator circuitry, the RF signal is provided to a low noise amplifier (LNA) 120 which, depending on implementation, can be a current mode low noise transconductance amplifier (LNTA) or a voltage mode LNA. As used herein, the terms “low noise amplifier” and “LNA” encompass both a current mode LNTA and a voltage mode LNA, unless specifically stated otherwise. As shown, LNA 120 may be implemented with a plurality of units 120₀₋ₙ, also called “slices.” Depending on an amount of desired gain, one or more of slices 120₀₋ₙ can be enabled to amplify the incoming RF signal.

As further shown in FIG. 1, a capacitive attenuator is coupled to an input of LNA 120, which may be implemented with a series-coupled capacitor C3 and programmable parallel-coupled capacitance C4. After amplification in LNA 120, the RF signal is provided to a mixer 125 through a coupling capacitor CC.

In various embodiments, mixer 125 may be implemented as a complex passive mixer (and thus is shown in FIG. 1 as mixer 125_{I, Q}). Understand that as used herein, for this and other components of the complex circuitry illustrated, numerals may be used without subscript to refer to the complex circuitry generally, and discussion of a given signal path, e.g., I or Q signal path, may apply equally to the other signal path. Also note, other implementations of the mixer are possible and can include active mixers. Mixer 125 is configured to downconvert the RF signal to a lower frequency signal, e.g., an intermediate frequency (IF) signal having separate in-phase and quadrature portions, namely I and Q portions that are respectively provided to I and Q signal paths.

In the embodiment shown in FIG. 1, passive mixer 125 may be implemented with switches, e.g., metal oxide semiconductor field effect transistors (MOSFETs) that are controlled by mixing signals, e.g., local oscillator (LO) signals output from a local oscillator. As shown, differential baseband I and Q signals at IF can be generated in each of I and Q signal paths by way of mixing signals LO_IP, LO_IN and LO_QP, LO_QN. From there, the IF signals are provided to a programmable gain amplifier (PGA), implemented in the FIG. 1 embodiment as a transimpedance amplifier (TIA) 130. TIA 130 is formed with an operational amplifier (op amp) and feedback filter formed of capacitor Ctia and resistor Rtia (e.g., a first order filtering function). TIA 130 operates to convert mixer IF current into a voltage signal. In other implementations, the PGA may be implemented as a voltage mode PGA. As used herein, the terms “programmable gain amplifier” and “PGA” encompass both a current mode TIA and a voltage mode PGA, unless specifically stated otherwise.

Note that LNA 120, mixer 125 and TIA 130 constitute a second gain control region of receiver 100. Although embodiments are not limited in this regard, in one particular embodiment, this second gain control region may have a controllable gain that ranges from 0 dB to 33 dB (e.g., with nominally 2 dB steps).

Still with reference to FIG. 1, nodes at the output of TIA 130 can be dynamically controlled to switch signals to a selected one of two different paths of receiver 100 depending upon an active wireless protocol. To this end, a controller 170 may operate to configure receiver 100 to pass IF signals output from TIA 130 to circuitry of one of two selectable paths, namely to components of a first path 155_{I, Q}, which may be implemented as a high-performance signal processing path, or to components of a second path 142_{I, Q}, which may be implemented as a low-power signal processing path. To effect this control, controller 170 may dynamically control one of the paths to be active and the other path to be powered off. In this way, the inactive path offers a high impedance when off to not load the active path. In another implementation, controller 170 may be coupled to switching circuitry that it controls to direct the IF signals to one of the first and second paths. While not shown specifically in FIG. 1, understand that this switching circuitry may be implemented as a plurality of MOSFETs that couple to nodes 141_{I, Q}, and operate under control of controller 170 to direct IF signals output from TIA 130 to a given one of these multiple paths. Of course, other types of switching circuitry or other control mechanisms can be used in other implementations.

In the particular embodiment shown in FIG. 1, first path 155 may include circuitry for processing signals of a high-performance wireless protocol, such as a Wi-Fi protocol. In turn, second path 142 may include circuitry for processing signals of a relaxed performance wireless protocol such as a given low-power wireless protocol, such as one or more of a Bluetooth or Wi-SUN protocol. Of course while described with these particular wireless protocols for purposes of discussion, understand that embodiments are not limited in this regard and in other implementations, these different paths may be used to process signals of other wireless protocols.

When a high-performance wireless protocol is active and communicating, controller 170 configures first signal path 155 to be active, by coupling the output of TIA 130 to a low pass filter (LPF) 145 for low pass filtering. In one embodiment, LPF 145 can be implemented with a biquadratic (biquad) filter. Although not shown for ease of illustration in FIG. 1, LPF 145 may include a PGA to control a gain of the biquadratic filter. In an embodiment, LPF 145 constitutes a third gain control region of receiver 100. Although embodiments are not limited in this regard, in one particular embodiment this third gain control region may have a controllable gain of between −10 dB to 20 dB (e.g., with 2 dB steps). Note that in the implementation of FIG. 1, additional anti-aliasing filtering may be performed by RC components (namely resistor R_{AAF} and capacitor C_{AAF}).

The filtered IF signal output from LPF 145 is provided to a digitizer, namely an analog-to-digital converter (ADC) 150_{I, Q}. ADC 150 may be implemented as a high-performance ADC, typically a wide-band ADC, such as a successive approximation register (SAR) ADC. However in other implementations such as for 2G cellular the high-performance ADC may be implemented as a narrow-band ADC, such as a delta-sigma ADC. The digitized output of ADC 150 (WIFIADC_OUT) is provided to a demodulator (which may be implemented in a digital signal processor (DSP), not shown for ease of illustration in FIG. 1).

When a low-power wireless protocol is active and communicating, controller 170 configures second signal path 142 to be active and disables first path 155 (and/or controlling switching circuitry) to couple the output of TIA 130 to a second ADC 140_{I, Q}. In one or more embodiments, ADC 140 may be implemented as a narrow-band ADC, and may consume less power than ADC 150. For example, ADC 140 may be implemented as a delta-sigma ADC or another low-power ADC. In one particular implementation, ADC 140 is an auxiliary ADC (separate from ADC 150) that is used in high-performance wireless protocols (such as Wi-Fi) for digitizing temperature information, in turn used for performing temperature compensation of a crystal oscillator during such Wi-Fi operation. In this way, an auxiliary ADC already present and used during a Wi-Fi mode is repurposed to be part of the signal processing path for a low-power mode, further reducing chip area via this repurposing.

Thus when a lower power wireless protocol is active, ADC 140 is controlled to be a part of second path 142 to digitize IF signals output from TIA 130. The digitized output of ADC 140 (LPWADC_OUT) is provided to a demodulator (not shown for ease of illustration in FIG. 1). Note that this demodulator is configured for the given low-power wireless protocol, and in one case may be implemented in the same DSP as the high-performance demodulator. Although shown at this high level in the embodiment of FIG. 1, many variations and alternatives are possible.

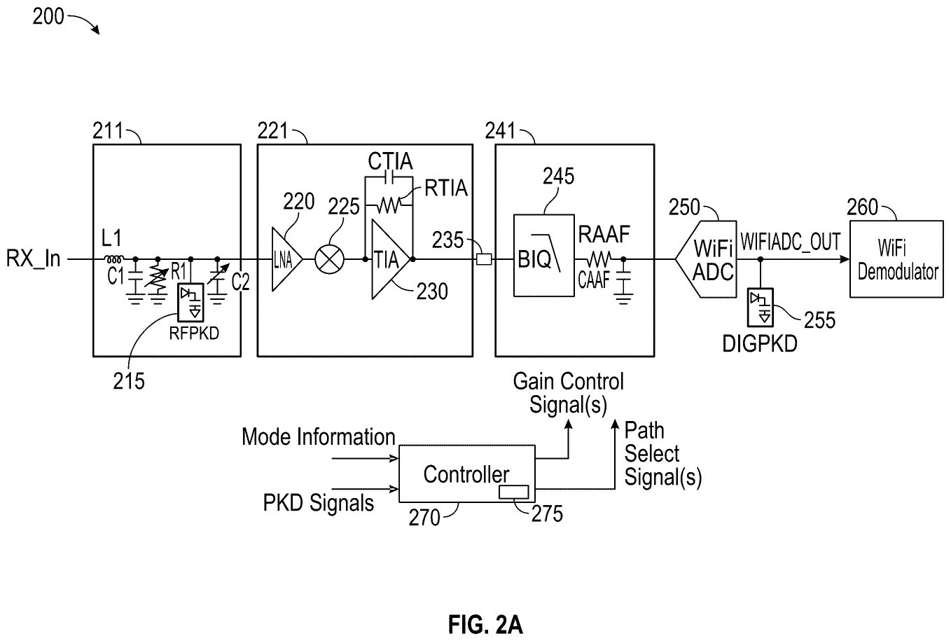

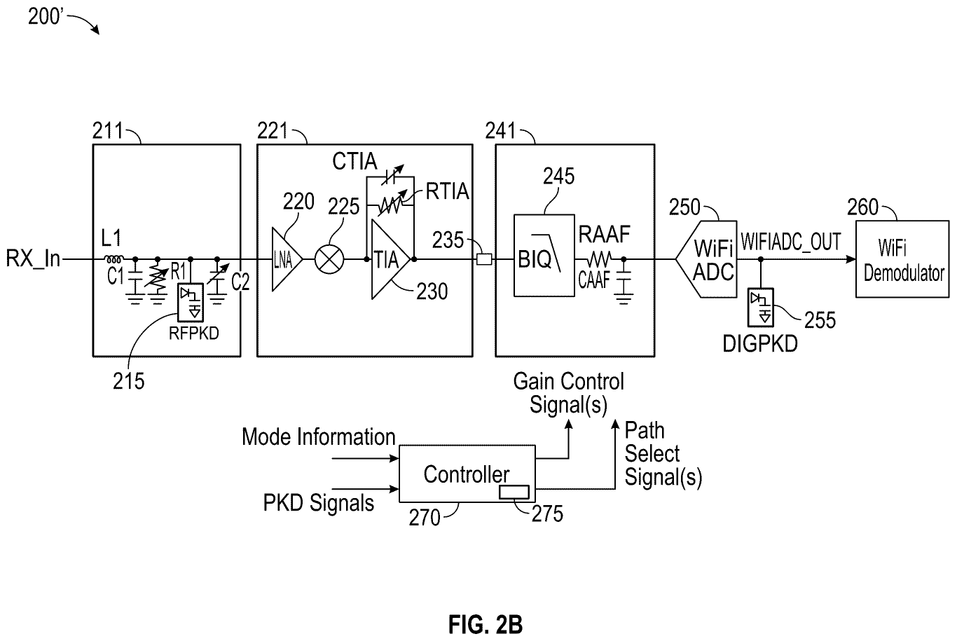

Referring now to FIG. 2A, shown is a block diagram of a receiver in accordance with an embodiment. As shown in FIG. 2A, receiver 200 is a unified receiver architecture that is configured for a high-performance mode. Also understand that only a single quadrature path is shown for ease of illustration.

Receiver 200 receives an incoming RF signal (RX_In) (e.g., from an antenna). The RF signal is provided to an attenuator, which in the embodiment of FIG. 2A is implemented as a passive gain network, e.g., including parallel-coupled capacitance (C2) and resistance (R1). In different embodiments, one or more of these RC components can be dynamically controlled to control an amount of attenuation, such that the attenuator is considered one of the gain components of receiver 200, namely a first gain control region 211 of receiver 200. Although embodiments are not limited in this regard, in one particular embodiment this attenuator may provide for a controllable gain of −15 dB to 9 dB (e.g., with approximately 2 dB steps per update). In one embodiment, resistance R1 and/or capacitance C2 may be dynamically controlled to adjust the gain setting of first gain control region 211.

After any attenuation in this front-end attenuator, the RF signal is provided to a LNA 220 which, depending on implementation, can be a current mode LNTA or a voltage mode LNA. Although shown in the embodiment of FIG. 2A as a single-ended LNA, other implementations may process RF signals differentially, using a differential LNA. After amplification in LNA 220, the RF signal is provided to a mixer 225, which down converts the RF signal to a lower frequency signal, e.g., an IF signal. Although shown in the embodiment of FIG. 2A as a single-balanced passive mixer, other implementations with differential LNAs may process the differential outputs from the LNA with a double-balanced passive mixer. From there, the IF signal is provided to a PGA, implemented in the FIG. 2A embodiment as a TIA (formed by an amplifier 230 and feedback filter formed of capacitor C_{TIA} and resistor R_{TIA} (e.g., a first order filtering function)). TIA 230 operates to convert mixer IF current into a voltage signal. In other implementations, the PGA may be implemented as a voltage mode PGA.

Note that LNA 220, mixer 225 and TIA 230 constitute a second gain control region 221 of receiver 200. Although embodiments are not limited in this regard, in one particular embodiment, second gain control region 221 may have a controllable gain that ranges from 0 dB to 33 dB (e.g., with nominally 2 dB steps). In one or more embodiments, for operation in a high-performance mode, the components of second gain control region 221 may be configured for high performance and thus higher power consumption. As an example, in one implementation second gain control region 221 may consume approximately 8 milliamperes (mA) of current during high performance operation.

Still with reference to FIG. 2A, the output of TIA 230 is provided to a switching circuit 235. Although shown at a high level in FIG. 2, understand that switching circuit 235 may be implemented with a plurality of MOSFETs or other switches that can be controlled to pass the IF signals output from TIA 230 to a LPF 245, implemented in the embodiment of FIG. 2A with a biquadratic filter. In other implementations, such switching circuitry can be avoided by presenting an inactive path as a high impedance when off.

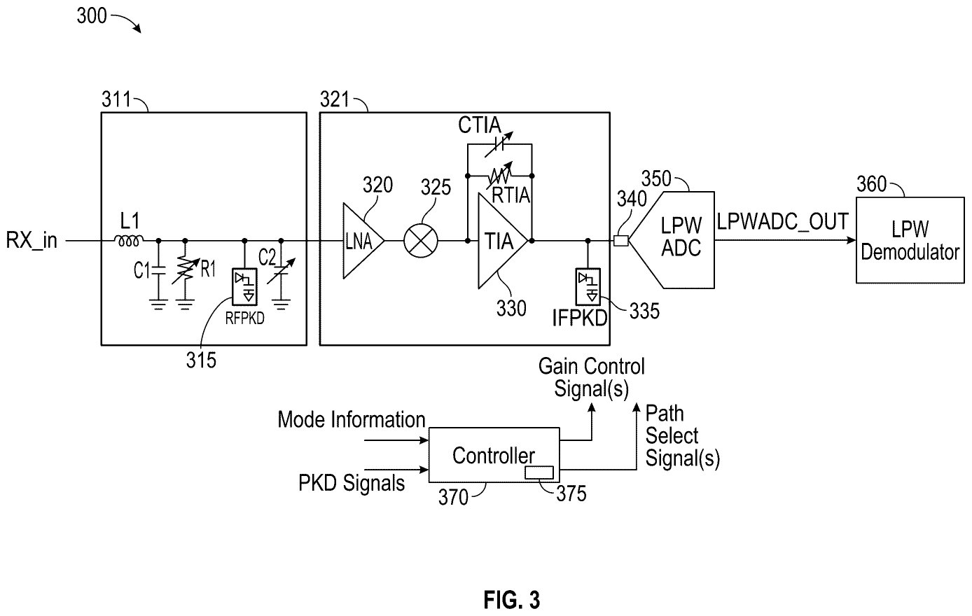

In FIG. 2A, only this single path having LPF 245 coupled to switch circuit 235 is illustrated; understand that at least one additional signal processing path also couples to switching circuit 235 for use in a low-power mode, as described further below with regard to FIG. 3. To effect control of switches of switch circuitry 235, a controller 270 is present, described in further detail below.

Although not shown for ease of illustration in FIG. 2A, LPF 245 may include a PGA to control a gain of the biquadratic filter. In the embodiment shown, LPF 245 constitutes a third gain control region 241. Although embodiments are not limited in this regard, in one particular embodiment third gain control region 241 may have a controllable gain of between −10 dB to 20 dB (e.g., with 2 dB steps). Note that in the implementation of FIG. 2A, additional anti-aliasing filtering may be performed by RC components (namely resistor R_{AAF} and capacitor C_{AAF}). In one or more embodiments, for operation in a high-performance mode, the components of third gain control region 241 may be configured for high performance and thus higher power consumption. As an example, in one implementation third gain control region 241 may consume approximately 4.5 mA of current during high performance operation.

Still referring to FIG. 2A, the filtered IF signal output from LPF 245 is provided to an ADC 250, which may be configured to digitize signals of a high-performance wireless protocol such as Wi-Fi signals. In one implementation, for operation in a high-performance mode, ADC 250 may be configured for wide-band operation, e.g., having 10/20/40 megahertz (MHz) bandwidth. In this implementation, ADC 250 may consume approximately 4 mA of current during high performance operation.

The digitized output of ADC 250 (WiFi_ADC_Out) is provided to a DSP 260, which includes a Wi-Fi demodulator to demodulate the digital signals. In an embodiment, DSP 260 also may analyze the channel filtered output to determine received signal strength indicator (RSSI) information, which may be used to perform fine tuning of one or more of the gain components, in certain cases.

Still referring to FIG. 2A, the RF signal after attenuation is further provided to a first peak detector 215, which operates as a wide-band detector to compare the power of the RF signal output from attenuator circuitry to a first threshold. First peak detector 215 may operate to sense the incoming signal at RF and provide an estimate of an incoming undesired blocker at an offset from the desired signal. For example, the offset can be 400 MHz away, and the blocker can be 80 MHz wide. Thus, first peak detector 215 primarily helps to improve out-of-band blocking performance and coexistence. When the RF signal level exceeds this threshold, peak detector 215 outputs an active detection signal, RFPKD, to controller 270, which may perform gain control based at least in part on this information.

FIG. 2A also shows a digital peak detector 255 coupled to the output of ADC 250. Although shown as a separate component, understand that in some embodiments ADC 250 may perform peak detection as part of digitization, essentially making this peak detection “free” (e.g., when ADC 250 is implemented as a SAR ADC). This digital peak detector can be used to detect saturation levels since it includes blocker information (as it is located prior to a channel select filter in DSP 260). Digital peak detector 255 operates to compare this digital output to another threshold. As with the discussion above, when the digital signal level exceeds this threshold, peak detector 255 outputs an active detection signal, DIGPKD, to controller 270.

With the above-described example gain controllability for the first, second and third gain control regions, the receiver overall may have a controllable gain total (Gtotal) of 87 dB from −25 dB to 62 dB. More specifically, each of the individually controllable gain control regions may have maximum gain settings of, respectively, 9 dB, 33 dB and 20 dB (corresponding to max(G1, G2, G3)). Also note that this discussion of FIG. 2A enumerates the independent gain control regions as “first,” “second,” and “third” gain control regions. Understand that this enumeration is for purposes of convenience and discussion only, and these different regions can be enumerated differently.

Controller 270, in an embodiment, may be implemented as a dedicated microcontroller or other programmable hardware control circuit such as a general-purpose processor or other programmable logic. In other cases, controller 270 may be implemented using other hardware circuitry, firmware, software and/or combinations thereof to determine an operating mode of receiver 200.

As shown in FIG. 2A, controller 270 receives mode information (e.g., from a processor) that identifies an operating mode of receiver 200, namely a given active communication protocol. Based at least in part on the mode information, controller 270 is configured to control switching circuitry 235 to cause the output of TIA 230 to be routed to LNA 245 when a high-performance mode (e.g., a Wi-Fi mode) is active. Or alternately, controller 270 disables a low power path, which presents as a high impedance to cause the TIA output to be routed to LNA 245. In addition to controlling switching circuitry 235 via illustrated path select signals, controller 270 also may appropriately configure the various components discussed above for high performance operation, by setting appropriate bandwidths, power levels and so forth.

Controller 270 is also configured to control gain settings of various gain components within receiver 200 based on the detected outputs from one or more of peak detectors 215 and 255. Furthermore, understand that controller 270 may efficiently perform this gain control within a small time window, e.g., completely within a preamble portion of a data communication, such that no payload data of the communication is lost.

As further illustrated, controller 270 includes a storage 275, which in embodiments may be implemented as a non-volatile storage or other non-transitory storage medium. Non-volatile storage 275 may store code or other instructions that when executed cause controller 275 to perform the configuration operations described herein and further to perform gain control, e.g., using gain control information stored in one or more tables present in non-volatile storage 275.

In some embodiments, it is further possible to configure a unified receiver for lower power operation while in a high-performance mode. For example, for certain types of Wi-Fi communications such as for beacon operations, it is possible to operate on the receiver at lower power consumption levels. Referring now to FIG. 2B, shown is a block diagram of a receiver in accordance with another embodiment.

In general, receiver 200′ is configured the same as receiver 200 of FIG. 2A, and thus the above discussion applies. However, for purposes of lower power operation in a high-performance mode, controllable RC components may be present to provide filtering for TIA 230. Thus in FIG. 2B, these RC components are shown as programmable capacitances and resistances, respectively.

Also in the embodiment of FIG. 2B, controller 270 may appropriately configure one or more components for reduced power consumption. For example, second gain control region 221 may be controlled to operate with lower power consumption, e.g., approximately 6.5 mA. Similarly, LPF 245 of third gain control region 241 may operate with lower power consumption, e.g., approximately 2.5 mA. Finally, ADC 250 also may be configured to operate at lower power consumption levels, e.g., approximately at 3 mA. With such power controllability, receiver 200′ may operate at approximately 25% lower current consumption than receiver 200, as the various components can operate with degraded allowable performance in this low power mode.

A unified receiver architecture in accordance with an embodiment also may be configured to operate in a low-power mode such as may be used for purposes of a Bluetooth communication. Referring now to FIG. 3, shown is a block diagram of a receiver in accordance with another embodiment. More specifically, receiver 300 is a unified receiver that is configured for operation in a low-power mode. In general, receiver 300 may include many of the same components as receiver 200 and thus such components are not specifically discussed (with respect to numerals of the ‘300’ series, instead of the ‘200’ series of FIG. 2A).

Note however that in FIG. 3, receiver 300 is configured so that a second signal processing path coupled to an output of switching circuitry 340 is present. As shown, this path includes a low power wireless (LPW) ADC 350, which in an embodiment may be implemented as a delta-sigma ADC. ADC 350 may be configured for narrow-band operation (e.g., 2 MHz) unlike ADC 250, which operates at wide-band, thus saving current while providing a higher dynamic range. The resulting digitized output (LPWADC_OUT) is provided to a LPW demodulator 360 which, in an embodiment may be implemented in DSP that also includes Wi-Fi demodulator 260.

In general, the remainder of signal processing path of receiver 300 is the same as receiver 200 of FIG. 2A. However, note that in the low-power configuration, instead of a digital peak detector, an IF peak detector 335 provides power information to controller 370. Peak detector 335 operates as a wide-band detector to compare this IF signal power to a second threshold (Pth2). Peak detector 235 operates to estimate an 80 MHz channel along with filtering from TIA 330. Peak detector 335 located at the output of TIA 330 provides an indication of headroom limitation and can sense saturation conditions for adjacent channel interference (ACI) and alternative ACI (AACI). As with the discussion above, when the IF signal level exceeds this threshold, peak detector 335 outputs an active detection signal, IFPKD, to controller 270.

In various implementations, at least some of the components of receiver 300 may operate at significantly reduced power consumption levels, as compared to receiver 200. For example, second gain control region 321 may consume approximately 4 mA, or approximately less than half of that in receiver 200. Also note the absence of a LPF in receiver 300, thus saving the power consumption of third gain control region 241 of FIG. 2A. Furthermore, using a narrow-band ADC (e.g., 2 MHz bandwidth instead of 20 MHz bandwidth), approximately 0.5 mA current consumption occurs using ADC 350. As a result, an overall power consumption level of receiver 300 may be approximately 70% lower than for receiver 200.

In at least one implementation, the required attenuation range increase to accommodate for limited programmability in TIA 330 could be achieved via capacitor C2 present in first gain control region 311. However, for purposes of gain programmability, controllable RC components may be present to maintain the same narrow bandwidth in TIA 330. Thus in FIG. 3, these RC components are shown as programmable capacitances and resistances, respectively. Furthermore, note that components of the first signal processing path used for high performance mode, namely LPF 245 and ADC 250, may be disabled during a low-power mode, avoiding their power consumption.

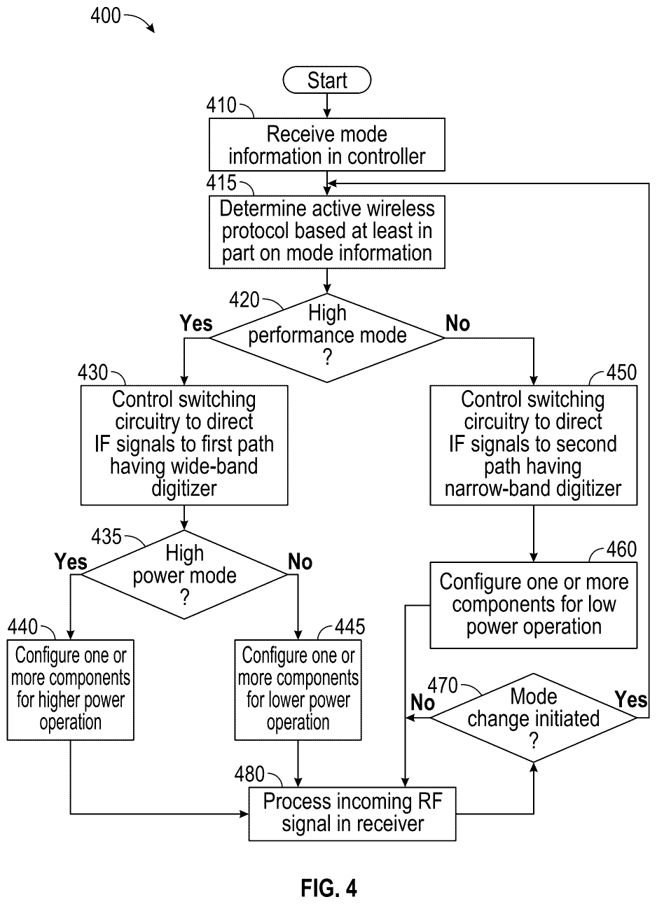

Referring now to FIG. 4, shown is a flow diagram of a method in accordance with an embodiment. More specifically as shown in FIG. 4, method 400 is a method for dynamically configuring a unified receiver architecture for operation in a selected one of multiple modes. While these different modes can vary in different implementations, for purposes of discussion assume presence of at least a high-performance mode and a low-power mode. Method 400 may be performed by a controller that may be implemented on a single integrated circuit with the receiver circuitry. As such, method 400 may be performed by this controller alone and/or along with firmware and/or software.

Method 400 begins at block 410 where mode information is received in the controller. Such mode information may be received from a host processor and includes an indication of a given wireless protocol that is to be activated. In some cases, this mode information may be in the form of a time-sliced schedule, where different time windows are allocated to different wireless protocols, e.g., a given periodic interval for each of multiple protocols. At block 415 the controller may determine an active protocol based at least in part on this mode information. From this determination, at diamond 420 it is determined whether a high-performance mode is active. If so, control passes to block 430 where the controller may cause switching circuitry (when present) to direct IF signals output from a PGA to a first path of the receiver that has a wide-band digitizer. For example, with reference back to FIG. 1 this wide-band digitizer is ADC 150, implemented as a SAR ADC.

Still referring to FIG. 4, next it is determined at diamond 435 whether a high power mode is active in this high-performance mode. Note that this high power mode, in one example, may be for Wi-Fi data communications. In such instance, control passes to block 440 where one or more components of the receiver are configured for higher power operation. For example, one or more of a biquad filter and ADC can be configured for higher power operation. Instead if it is determined that a high power mode is not indicated, e.g., where Wi-Fi beaconing operations are to occur, control passes to block 445 where one or more components can be configured for lower power operation. Continuing with this same example, the biquad filter and ADC can be configured for lower power operation.

In either instance, the receiver is thus configured appropriately for the given mode of operation and accordingly, control passes to block 480 for processing an incoming RF signal in the receiver.

Still referring to FIG. 4, if a high-performance mode is not indicated, control passes from diamond 420 to block 450, where the controller may cause switching circuitry (when present) to direct IF signals output from a PGA to a second path of the receiver that has a narrow-band digitizer. For example, with reference back to FIG. 1 this narrow-band digitizer is ADC 140, implemented as a delta-sigma ADC. Thereafter at block 460, one or more components of the receiver are configured for low power operation. For example, the biquad filter and ADC can be disabled, and other components such as LNA, mixer, and/or TIA can be configured for lower power operation. With this appropriate receiver configuration for a lower power operation, control passes to block 480 for processing incoming RF signals.

As further shown, it may be determined at diamond 470 whether a mode change is initiated. Such mode change may occur in response to a termination of a given time slice in a time-sliced operation or in response to receipt of updated mode information. As shown, control passes back to block 415, where operation may proceed as discussed above for re-configuration of the unified receiver architecture for a selected mode of operation. Understand while shown at this high level in the embodiment of FIG. 4, many variations and alternatives are possible.

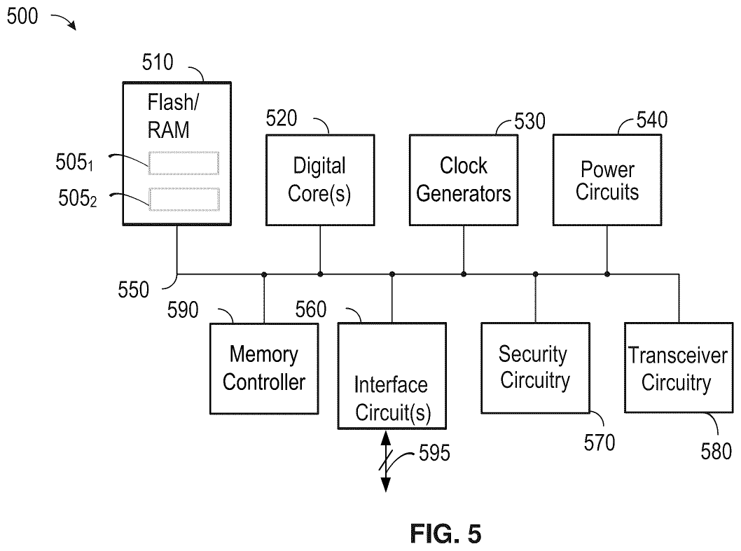

Referring now to FIG. 5, shown is a block diagram of a representative integrated circuit 500 that includes power control circuitry as described herein. In the embodiment shown in FIG. 5, integrated circuit 500 may be, e.g., a multi-mode wireless transceiver that may operate according to one or more wireless protocols or other device that can be used in a variety of use cases. In one or more embodiments, the circuitry of integrated circuit 500 shown in FIG. 5 may be implemented on a single semiconductor die or implemented on separate dies for wireless communication, MCU compute, external flash and/or other IP blocks needed to perform various functionalities.

Integrated circuit 500 may be included in a range of devices, but for purposes of discussion, it may be incorporated into an IoT device. In the embodiment shown, integrated circuit 500 includes a memory system 510 which in an embodiment may include volatile storage, such as RAM and non-volatile memory such as a flash memory. The flash memory is a non-transitory storage medium that can store instructions and data. These instructions include a set of instructions that, when executed, cause control circuitry to configure a unified receiver architecture for a selected wireless protocol of multiple wireless protocols, e.g., in a time-sliced manner and for performing power control of various gain control elements based at least in part on peak detector outputs, as described herein.

As further shown in FIG. 5, memory system 510 may store first code 505₁ for performing receiver configuration control, and second code 505₂ for performing power control as described herein. Integrated circuit 500 also may include a memory controller 590.

Memory system 510 couples via a bus 550 to one or more digital cores 520, which may include one or more cores and/or microcontrollers that act as processing units of the integrated circuit, and which may perform power control and configuration operations as described herein. In turn, digital cores 520 may couple to clock generators 530 which may provide one or more phase locked loops or other clock generator circuitry to generate various clocks for use by circuitry of the IC.

As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry (such as another IC that can couple to IC 500 via a link 595). IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Matter, Zigbee, Bluetooth, IEEE 802.11, IEEE 802.15.4, cellular communication or so forth. Understand while shown with this high-level view, many variations and alternatives are possible.

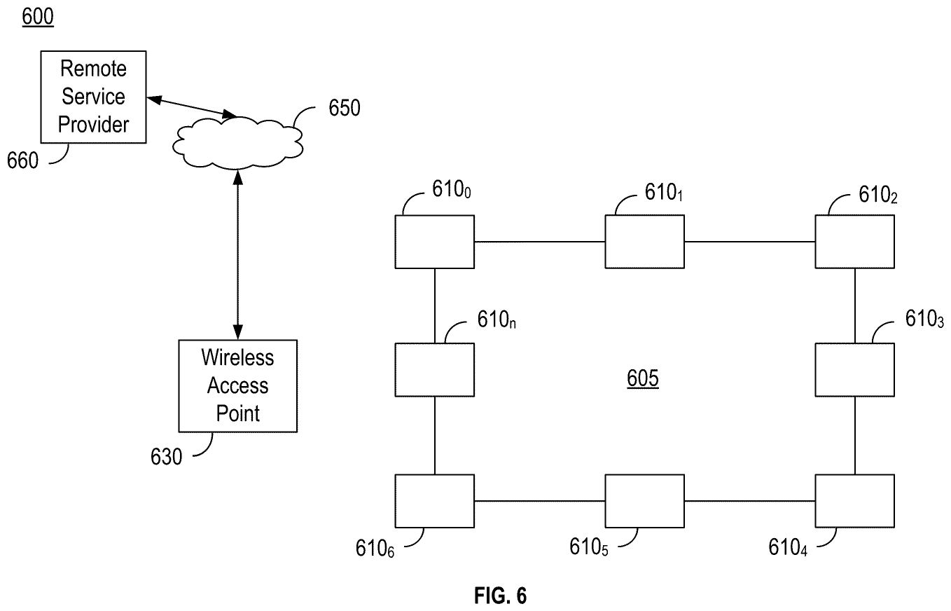

ICs such as described herein may be implemented in a variety of different devices as described above. Referring now to FIG. 6, shown is a high-level diagram of a network in accordance with an embodiment. As shown in FIG. 6, a network 600 includes a variety of devices, including IoT and other wireless devices that may include a unified receiver architecture as described herein.

In the embodiment of FIG. 6, a wireless mesh network 605 is present, e.g., in a building having multiple wireless devices 610₀₋ₙ. As shown, wireless devices 610, which may be IoT or other wireless devices, couple to an access point 630 that in turn communicates with a remote service provider 660 via a wide area network 650, e.g., the Internet. Understand while shown at this high level in the embodiment of FIG. 6, many variations and alternatives are possible.

Embodiments provide a current-optimized receiver architecture that can be used in high and low performance modes. In this way, a single unified receiver architecture is provided that does not compromise performance for each mode, thereby breaking a tradeoff between conflicting design paradigms.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A receiver comprising:
a low noise amplifier (LNA) to receive and amplify a radio frequency (RF) signal;
a mixer to downconvert the RF signal to an intermediate frequency (IF) signal;
a programmable gain amplifier (PGA) coupled to the mixer to amplify the IF signal;
a first digitizer coupled to the PGA to digitize the IF signal to a first digitized signal when the RF signal is of a first wireless protocol;
a second digitizer coupled to the PGA to digitize the IF signal to a second digitized signal when the RF signal is of a second wireless protocol; and
a controller to direct the IF signal to the first digitizer via a first path when the first wireless protocol is active and to direct the IF signal to the second digitizer via a second path when the second wireless protocol is active.

2. The receiver of claim 1, further comprising switching circuitry, wherein the controller is to control the switching circuitry to:
direct the IF signal to the first digitizer via the first path when the first wireless protocol is active; and
direct the IF signal to the second digitizer via the second path when the second wireless protocol is active.

3. The receiver of claim 1, wherein the first path comprises a filter coupled between the PGA and the first digitizer.

4. The receiver of claim 3, wherein the second path comprises a direct path between the PGA and the second digitizer.

5. The receiver of claim 1, wherein:
the first digitizer has a first power consumption level; and
the second digitizer has a second power consumption level, the second power consumption level lower than the first power consumption level.

6. The receiver of claim 5, wherein:
the first digitizer comprises a wide-band analog-to-digital converter (ADC); and
the second digitizer comprises a narrow-band ADC.

7. The receiver of claim 5, wherein the controller is to disable at least the first digitizer when the second wireless protocol is active.

8. The receiver of claim 1, wherein the second digitizer is further to digitize sensor information when the first wireless protocol is active.

9. The receiver of claim 1, further comprising:
a first demodulator coupled to the first digitizer, the first demodulator to demodulate the first digitized signal according to a first demodulation scheme; and
a second demodulator coupled to the second digitizer, the second demodulator to demodulate the second digitized signal according to a second demodulation scheme.

10. The receiver of claim 1, further comprising:
a first power detector coupled to an input of the LNA, the first power detector to output a first detection signal in response to the RF signal exceeding a first threshold; and
a second power detector coupled to an output of the first digitizer, the second power detector to output a second detection signal in response to the first digitized signal exceeding a second threshold, wherein the controller is to control at least one gain component of the receiver based at least in part on the first detection signal or the second detection signal.

11. The receiver of claim 10, further comprising a third power detector coupled to an output of the PGA, wherein the third power detector is active when the second wireless protocol is active.

12. A method comprising:
when a first wireless protocol is active, configuring, via a controller, a unified receiver to provide a downconverted signal to a first path of the unified receiver, the first path comprising a filter to filter the downconverted signal and a first digitizer to digitize the filtered downconverted signal into a first digital signal; and
when a second wireless protocol is active, configuring, via the controller, the unified receiver to provide the downconverted signal to a second path of the unified receiver, the second path comprising a second digitizer to digitize the downconverted signal into a second digital signal.

13. The method of claim 12, further comprising configuring the unified receiver in response to mode information, the mode information to indicate whether the first wireless protocol or the second wireless protocol is active.

14. The method of claim 13, further comprising dynamically re-configuring the unified receiver from providing the downconverted signal to the first path to providing the downconverted signal to the second path in response to updated mode information that indicates that the second wireless protocol is active.

15. The method of claim 12, wherein configuring the unified receiver comprises controlling switch circuitry coupled to the first path and the second path, the switch circuitry to receive the downconverted signal from a common path of the unified receiver, the common path to receive and downconvert a radio frequency signal to the downconverted signal, the common path active when the first wireless protocol is active and when the second wireless protocol is active.

16. The method of claim 12, wherein configuring the unified receiver comprises:
configuring the first digitizer to have a first power consumption level when a first mode of the first wireless protocol is active; and
configuring the first digitizer to have a second power consumption level when a second mode of the first wireless protocol is active, the second power consumption level less than the first power consumption level.

17. The method of claim 12, further comprising:
processing the downconverted signal in the first path at a first power consumption level; and
processing the downconverted signal in the second path at a second power consumption level, the second power consumption level less than the first power consumption level.

18. A wireless device comprising:
an antenna to transmit a transmit radio frequency (RF) signal and to receive a receive RF signal; and
an integrated circuit (IC) coupled to the antenna, the IC comprising:
a low noise amplifier (LNA) to receive and amplify the receive RF signal;
a mixer to downconvert the receive RF signal to a second frequency signal;
an amplifier coupled to the mixer to amplify the second frequency signal;
a first path comprising a filter to filter the second frequency signal and a first digitizer coupled to the filter to digitize the filtered second frequency signal to a first digitized signal;
a second path comprising a second digitizer to digitize the second frequency signal to a second digitized signal;
a first demodulator coupled to the first path to demodulate the first digitized signal;
a second demodulator coupled to the second path to demodulate the second digitized signal; and
a controller to direct the second frequency signal to the first path when a first wireless protocol is active and to direct the second frequency signal to the second path when a second wireless protocol is active.

19. The wireless device of claim 18, wherein the controller is to disable the filter and the first digitizer when the second wireless protocol is active.

20. The wireless device of claim 18, wherein the second digitizer is to digitize sensor information when the first wireless protocol is active, and to digitize the second frequency signal to the second digitized signal when the second wireless protocol is active, the second digitizer to operate at a lower power consumption level than the first digitizer.
